(19) United States
(12) Patent Application Publication
(10) Pub. No.: US 2008/0100586 A1
(43) Pub. Date: May 1, 2008

(54) Method and system for calibrating a touch screen

(75) Inventor: David Charles Smart, Johnston, IA (US)

Correspondence Address: DEERE & COMPANY, ONE JOHN DEERE PLACE, MOLINE, IL, 61265, US

(73) Assignee: DEERE & COMPANY

(21) Appl. No.: 11/588,657

(22) Filed: Oct. 26, 2006

(51) Int. Cl. G06F 3/041

(52) U.S. Cl. 345/173

(57) ABSTRACT

A method for calibrating a touch screen. Method may be comprised of determining an area for a region suitable for receiving, excluding activations determined to be located within a defined distance from the outer edge of the area determined for the region, accumulating a pattern of activations for a centroid within the region, and tuning a calibration factor to reposition the centroid within the center of the region.

### FIELD OF THE INVENTION

The present invention relates generally to touch screens, and more particularly to a system and method for calibrating a touch screen.

### BACKGROUND OF THE INVENTION

Touch screens are increasingly popular interactive devices with a multitude of applications such as cellular telephones, personal digital assistants (PDAs), laptop computers, and the like. A touch screen may be an input device over the television or a special computer screen that is used to simplify user input and response. The user touches the screen rather than a keyboard, keypad, or mouse to control the output. Touch screens generally work by sensing the position of a finger, stylus or other such object suitable for contacting the surface of a screen using sensors located in the screen surround. Despite the advantages of resistive-type touch screens, devices equipped with them almost always require re-execution of a calibration algorithm when the final product comes out of the box. Calibration is often necessary because it is difficult to perfectly align a touch screen's coordinates to the display behind the touch screen. If a button or other “live” feature on the display is to be properly activated, the coordinates of the area touched on the screen must be sufficiently close to the coordinates of the feature on the display. Otherwise, the software may not correctly act upon an input.

The problem of proper alignment and calibration is exacerbated by changing environmental conditions and system aging. Due to these factors, errors may be introduced between the perceived and actual touch coordinates on a touch screen. These errors may result in false activations and difficulty in activating the correct point of contact. Additionally, moving the display such that the viewing angle changes may also produce similar problems with activating the correct area of the touch screen. A common solution to the problem is to provide a manual calibration program. This type of program generally involves displaying a grid of test points at known locations. The user performing the calibration may touch each test point, and the test point information may be utilized to compensate for the touch screen readings so the actual location of the activation point corresponds to the perceived point. However, manual calibration programs often rely upon a user to accurately select the center of the test point, which may introduce error into the calibration.

Consequently, a system and method for automatically calibrating a touch screen to prevent erroneous activations is necessary.

### SUMMARY OF THE INVENTION

Accordingly, the present invention is directed to a system and method for automatically calibrating a touch screen. A method for calibrating a touch screen may be comprised of determining region parameters for a region defining a discrete area. Discrete area may be an area suitable for encompassing a plurality of touch sensors designated to perform a specific function. Method may further comprise accumulating a pattern of activations for a centroid within the region, and tuning a calibration factor to reposition the centroid within the center of the region. As a display is utilized, a centroid pattern of activations within any known button region may be accumulated. Activations within a determined threshold proximity to the edge of a button region may be excluded from a centroid calculation, as these activations may represent misses from adjacent buttons. If a centroid center is not in the center of the button region, one or more calibration factors may be adjusted to center the centroid within a desired region. Centroid centering may correct for drift due to component aging, as well as parallax errors due to mounting.

According to a second aspect of the present invention, a system for calibrating a touch screen is contemplated. System may be comprised of a touch sensor, a controller, and a software driver. System may determine region parameters for a region defining a discrete area. Discrete area may be an area suitable for encompassing a plurality of touch sensors designated to perform a specific function. System may be suitable for accumulating pattern of activations for a centroid within the region based on inputs received by the touch sensor. System may also be suitable for excluding activations determined to be located outside defined region parameters. System may tune a calibration factor to reposition the centroid within the center of the region. System may also adjust at least one calibration factor to center a centroid within a desired region.

It is to be understood that both the forgoing general description and the following detailed description are exemplary and explanatory only and are not restrictive of the invention as claimed. The accompanying drawings, which are incorporated in and constitute a part of the specification, illustrate an embodiment of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1 is an example of a touch screen suitable for implementation with a process for calibrating a touch screen in accordance with an exemplary embodiment of the present invention;

FIG. 2 is a flow diagram of a process for calibrating a touch screen in accordance with an exemplary embodiment of the present invention;

FIG. 3 is an illustration of a an exemplary example of touch screen display calibration in accordance with an embodiment of the present invention; and

FIG. 4 is a block diagram of a system for calibrating a touch screen in accordance with an exemplary embodiment of the present invention.

### DETAILED DESCRIPTION OF THE INVENTION

Reference will now be made in detail to the presently preferred embodiments of the invention, examples of which are illustrated in the accompanying drawings.

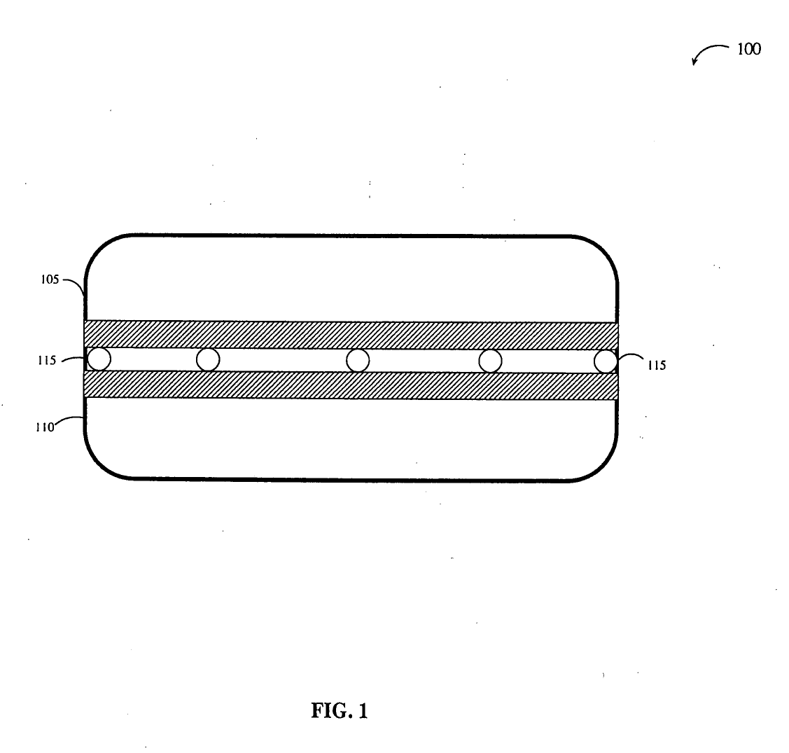

Referring to FIG. 1, an example of a touch screen suitable for implementation with a process for calibrating a touch screen in accordance with an exemplary embodiment of the present invention of a touch screen display 105 having touch screen surface overlaid on an underlying display device 110 that may be utilized with the various embodiments of the present invention is shown. The touch screen surface 105 may operate to sense and report the coordinate position of an operator activation such as a manual touch, stylus tip contact and the like. It is contemplated that touch screen display 105 may be a touch screen display add-on or an integrated touch screen monitor. Touch screen display add-on module may be a touch screen panel suitable for fitting substantially over an existing computer monitor. Integrated touch screen monitor may be a display having a touch screen built-in. Touch screen may further comprise a glass or acrylic panel coated with electrically conductive and resistive layers separated by separator dots 115.

It is contemplated that a touch screen 100 utilized with an embodiment of the present invention may be a resistive, capacitive, surface acoustic touch screen, infrared curtain or like touch screen. A resistive touch screen may refer to a pressure sensitive touch screen device suitable for receiving any type of contact input, such as finger, gloved hand, stylus, pen, or any pointing device. Resistive touch screen may be a four-wire, five-wire, 7-wire, 8-wire or like resistive touch screen. When pressure is applied to the screen the layers may be pressed together, causing a change in the electrical current and a touch event to be registered.

A capacitive screen may refer to a touch screen device that may be operative only with a finger input or like conductive input. A capacitive touch screen may consist of a glass panel with a capacitive or other such charge storing material surface coating. Circuits located at corners of the screen may measure the capacitance of a person touching the overlay. Frequency changes may be measured to determine the X and Y coordinates of the touch event. A further specific embodiment of a capacitive touch screen device may be a pen-touch device having an attached pen stylus suitable for providing readable touch force to a touch screen surface.

A surface acoustic touch screen device may refer to a touch screen device operable with a finger input, soft-tipped stylus input or a like impressible material suitable for creating a touch response. A surface acoustic wave touch screen may transmit acoustic waves across a clear glass panel with a series of transducers and reflectors. When a finger touches the screen, the waves may be absorbed, causing a touch event to be detected at that point. It is further contemplated that touch screen may be a near-field touch screen, infrared touch screen, or any other touch screen device not specifically enumerated. Additionally, touch screen may respond to single touch forces or multiple touches from a plurality of touch forces simultaneously, such as multiple users applying finger touch force to touch screen simultaneously.

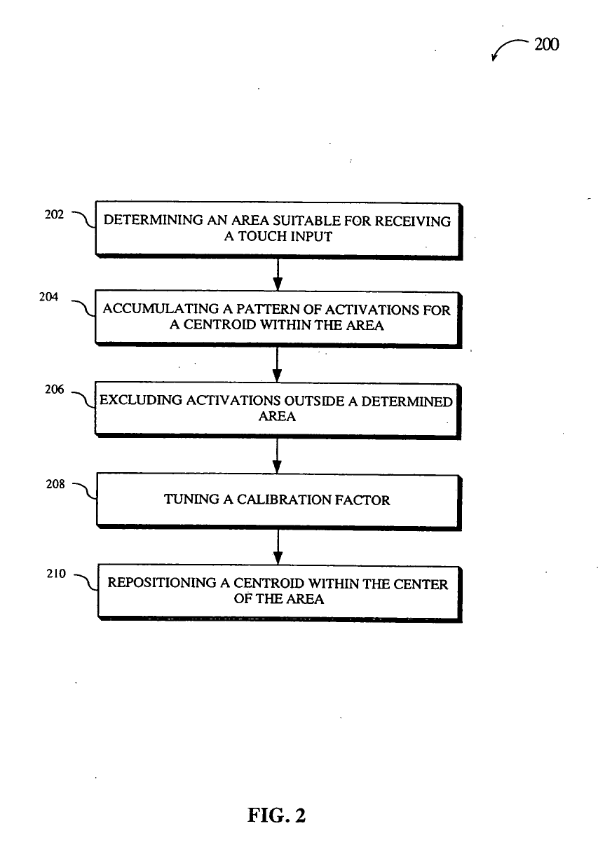

Referring to FIG. 2, a flow diagram of a method 200 for calibrating a touch screen in accordance with an exemplary embodiment of the present invention is shown. Method 200 may be comprised of determining region parameters for a region defining a discrete input area 202. Input area may be suitable for encompassing a plurality of coordinates corresponding to a pattern of signals designated to perform a specific function. Area may be substantially rectangular, circular, oval or any known shape having adequate surface area to detect a force. To aid in region parameter determination, a calibration reference point, located at coordinates corresponding to the approximate center of touch screen target, may define the center of the acceptable coordinate boundary. A coordinate map corresponding to a desired coordinate boundary may be created based on the calibration reference point. Coordinates defining a coordinate boundary may be equidistance from the calibration reference point, creating a substantially circular boundary, or may vary in distance from the calibration reference point, creating any desired boundary shape.

Method may also comprise accumulating a pattern of activations for a centroid within the region 204. Accumulation of centroid activations may be based upon an assumption that a user contacts a defined touch sensor region generally in the center of the region. As a user contacts the surface of a touch screen within a determined region, the center coordinates of the contact may be utilized to determine a region center. In response to an operator input, the operator touch sense or activation may be sensed at some coordinate within acceptable coordinate boundary. An operator activation outside boundary may be rejected, and a default calibration may be utilized.

To determine the coordinates of the touch location, a voltage gradient may be applied along the x-axis and the y-axis. When a finger or stylus presses the two layers together, or contacts the surface of a touch screen, the x-axis and y-axis voltages at the point of contact may be measured. It is contemplated that a method in accordance with an embodiment of the invention may correct errors affecting the “x” and “y” coordinates from a plurality of sources. For instance, error may arise from electrical noise, mechanical misalignment, scaling factors, and like sources. Additionally, user idiosyncrasies may be a source of error. For example, a finger or stylus utilized to activate a screen may not maintain continuous contact or pressure against the touch screen, causing misalignment of coordinates.

Method 200 may comprise excluding activations determined to be located within a defined distance from the outer edge of said area determined for said region 206. Such activations may be considered misses by the touch screen system, and may not be considered in making a centroid calculation.

Method 200 may further comprise tuning a calibration factor to reposition the centroid within the center of the region 208. A calibration factor may be tuned according to centroid activation accumulations. Tuning may be incremental based on centroid accumulation information as it is received, or tuning may be accomplished after all centroid accumulation has been gathered. Post centroid accumulation tuning may be rapid tuning or one or more calibration factors may be tuned slowly. Calibration factor tuning speed may be pre-determined, or may be determined by an individual user, based on the individual user's preference. Calibration factors may comprise offset, scale and linearity. Offset may refer to an integer indicating the distance or displacement from the beginning of an object within an array or data structure object up until a given element or point, presumably within the same object. Scale may refer to a factor error requiring translation from touch screen units to video screen units. Linearity may refer to the degree to which the actual location of a pixel on the touch screen corresponds with its intended location.

A touch screen may comprise a resolution of 4096 units of resolution in each axis. However, the embodiments of the present invention disclosed are not limited to a touch screen having 4096 resolution, and may suitable for a touch screen of any resolution. The resulting range of values is (0,0)-(4095, 4095). Touch screen parameters may be integers, however parameters are not limited to integers, and may be any incremental value desired by an operator. If a touch screen is physically installed up 100 units and left 50 units from an ideal installation, then when a user aims for the center of the picture, they may be activating the touch screen at location (2047+100, 2047+50). To correct for the offset error, offset may be subtracted out from raw touch data with the following equation:

Screen Corrected (x,y)=Touched (x,y)+Offset (−100, −50)

For scale factor error correction, a touch screen of resolution (4096, 4096) may be coupled over video screen with a desired resolution, for example, resolution (1600, 1200). To correct for scale factor error, units utilized in the touch screen may be translated to video screen units. Correcting for the scale factor error may compute a corrected point from the raw data by scaling, such as with the following equation:

Screen Corrected (x,y)=Touched (x,y)/Touch Resolution (4096, 4096)*Screen Resolution (1600, 1200)

Touch screen resolution factors may be modified to more precisely adjust the scale factor to match the screen resolution. Additionally, scale and offset corrections can be combined to effect both changes.

Method 200 may also comprise repositioning a centroid within the center of the area 210. Reposition may further comprise accepting a repositioning determination and fine tuning the reposition determination. Method may determine if a repositioning complies with a pre-determined centroid location, a centroid location based on received centroid accumulation data, or like parameters, including user log-in information and change in user detection.

In an alternative embodiment, method 200 may be suitable for detecting a change in users. Change in users may be detected utilizing a login process, key cycles, seat switch, or by a dramatic shift in the accumulated centroid. Method may further provide automatic calibration on a per-user basis based on user factors. Detecting a change in users may accommodate differing touch styles of different individuals, objects, or the like, which may prevent false activations caused by differing touch patterns of different users. Detection of user changes may also avoid the inconvenience of manual calibration, where a user or operator is required to re-calibrate a touch screen on a regularly scheduled basis, or upon the occurrence of drift.

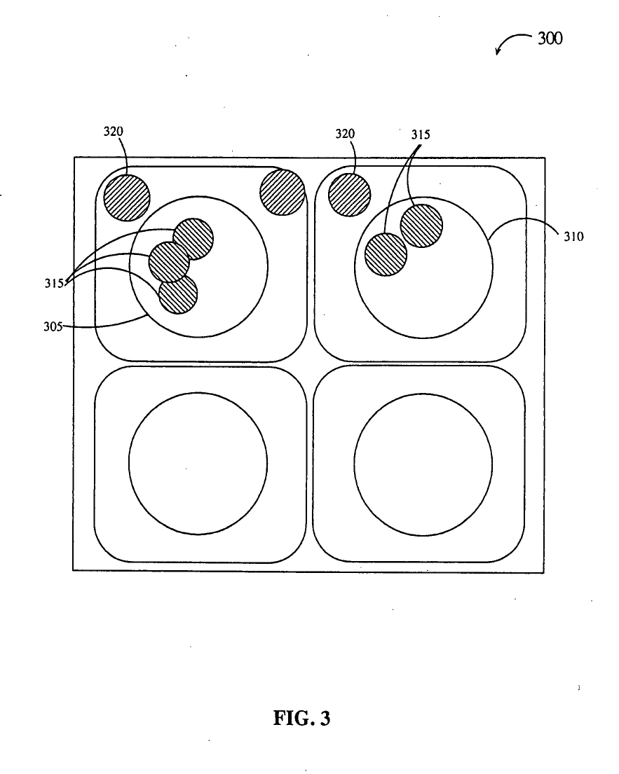

Referring now to FIG. 3, an exemplary example of touch screen display calibration 300 in accordance with an embodiment of the present invention is shown. Touch screen display may be calibrated using one or more touch screen targets 305, 310 that may define the edge of the coordinate boundary, such as the side of a square or rectangle or the shape of the calibration screen such as corners of a square, rectangle, triangle or any other shape. The calibration targets 305, 310 may be displayed either simultaneously with a prompt to touch each displayed target, or sequentially with the subsequent targets being displayed only after sensing an activation for a previous target.

As noted above, the actual activation at which an operator touches on target may vary, causing subsequent mapping of touch screen surface coordinates to underlying screen display to vary also. Even where the operator activation is within acceptable boundary, there may be difficulty achieving a close correlation between touch screen surface coordinates and respective pixel addresses on an underlying screen display, resulting in possible misalignment and incorrect command entry.

Calibration reference point may be defined by acceptable coordinate region parameters corresponding to a touch boundary. It is to be noted that while coordinate region parameters of calibration targets 305, 310 are shown as a substantially circular, however, region parameters may take other shapes such as a square, rectangle, ellipse, etc., as contemplated by one of skill in the art. When an activation is within acceptable coordinate boundary, the activation may be considered an acceptable activation 315 and the coordinates of the acceptable activation 315 may be accumulated and considered in a calibration calculation. However, when an actual activation is outside acceptable coordinate boundary, the activation may be considered an unacceptable activation 320 and may be excluded from the calculation, considered a missed or erroneous touch. In accordance with an embodiment of the present invention, the generation of computed reference calibration point may utilize data obtained from previous successful calibration operations. Accumulated acceptable and unacceptable activation data may be utilized to tune a centroid center back to an initial position, i.e., the original center of a touch region. In this manner, a touch region may remain centered or substantially centered at all times.

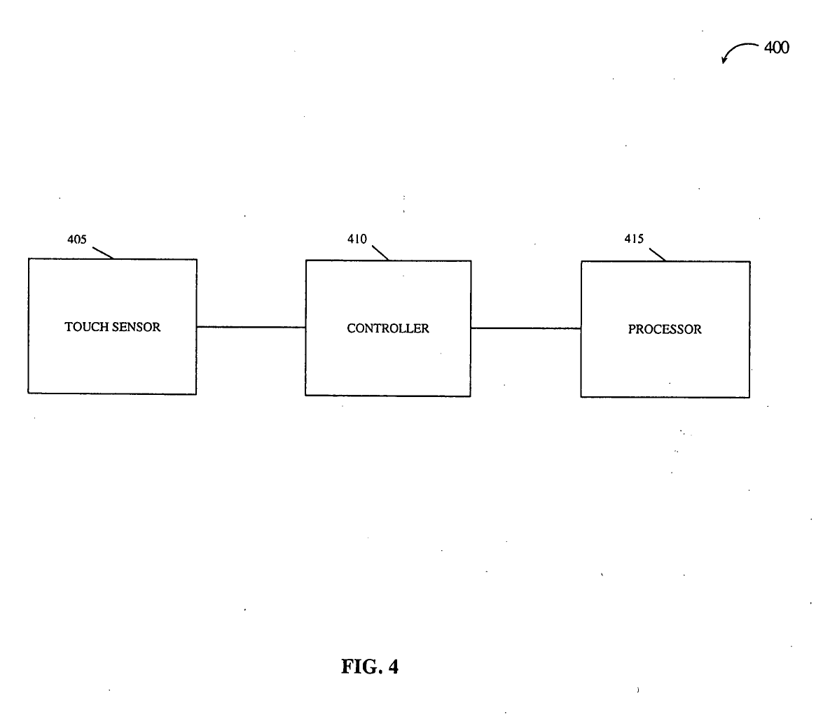

Referring to FIG. 4, a block diagram of a system 400 for calibrating a touch screen in accordance with an exemplary embodiment of the present invention is shown. System 400 may be comprised of a touch sensor 405, a controller 410, and a software processor 415 or driver. System may be suitable for implementing a method for automatically calibrating a touch screen in accordance with the various embodiments of the present invention, such as the method 200 disclosed above. For instance, system 400 may be suitable for determining region parameters for a region defining a discrete input area, accumulating a pattern of activations for a centroid within the region, excluding activations determined to be located within a defined distance from the outer edge of the region parameters determined for the region, tuning a calibration factor and repositioning the centroid within the center of the region.

A touch screen sensor 405 may be a clear glass panel with a touch responsive surface. The touch sensor/panel may be placed over a display screen so that the responsive area of the panel covers or substantially covers the viewable area of the video screen. Touch sensor 405 may employ any contemplated touch sensor technology, or any method of detecting touch input. Additionally, the touch sensor 405 may include electrical current or signal going through it and contacting the screen, causing a voltage or signal change. The voltage change may be utilized to determine the location of the touch to the touch screen. Touch sensors 405 may transmit signals to a controller for conversion into useable data. In an embodiment of the present invention, a touch screen matrix (not shown) may be coupled to the surface of touch screen display. Touch sensor 405 may communicate with a touch screen controller 410 that, in turn, communicates coordinate data to processor 415.

Touch screen controller 410 may be built into the chassis of touch screen display. Alternatively, touch screen controller 410 may be a separate unit or may be embodied as a control board within the processor 415. Controller 410 may be a small PC card that connects between the touch sensor and the PC. Controller 410 may gather centroid information from the touch sensor and translate it into computing system readable information. The controller 410 may be installed inside the monitor for integrated monitors, or housed in a rigid case for external touch add-ons, overlays and the like. The controller 410 may determine the type of computing interface or connection may be necessary. It is further contemplated that an integrated touch monitor may be comprised of an additional cable connection for a touch screen. Controller 410 may connect to a Serial/COM port, a USB port, or a like personal computing system. Additionally, controller 410 may be customizable for integration with devices such as digital video disc players, specialized computing systems and the like. Controller 410 may be suitable for real-time review of touch sensor data as it is transmitted.

In one embodiment, a controller 410 (digitizer or A/D) may apply a voltage source to an end of a conductive layer. A second conductive layer that may be located on an opposite sheet of glass may act as a potentiometer wiper. As the wiper is moved closer to one end of the resistive element, the resistance between the wiper terminal and that end terminal may decrease. A voltage test value read by the digitizer may depend on where the glass is touched and where the conductive surfaces come into contact. The controller 410 may then translate the voltage reading into a binary quantity representing, for example, the X-coordinate of the point where the screen was touched. The voltage potential may then be applied to the second surface's endpoints and the first surface may act as a potentiometer wiper, yielding a value that represents the Y-coordinate. The voltages produced by the electrical contact may be the analog representations of the position touched. The control electronics may transmit the coordinates of the position to a host computer. Touch sensors may transmit signals to a controller 410 for conversion into useable data. Controller 410 may be suitable for real-time review of touch sensor data as it is transmitted.

It is contemplated that a controller 410 may collect at least 500 or more accumulations per second. The accumulation rate may depend on factors such as background noise, controller quality and the like. A smart controller may also incorporate features such as the ability to interrupt the CPU when a touch is detected, as well as the ability to sample continuously at a set rate as long as the screen is being touched. It is further contemplated that the controller 410 may idle when the screen is not being touched.

Processor 415 may be a control logic processor, driver, or any like processor suitable for receiving and processing input data from the touch screen device controller 410. Furthermore, processor 415 may be a computer or may be embodied as a control logic printed circuit board within some other control device. In addition, processor 415 may further comprise a storage device such as a memory which may function as a database in which coordinates entered for each valid calibration operation are stored. Processor 415 may verify the validity of the coordinates of each actual activation. For example, processor 415 may determine whether the coordinates for each activation are within an acceptable coordinate boundary during coordinate accumulation. It should be appreciated that coordinate boundary may be a fixed boundary that is measured from or based on the location of calibration reference point. Alternatively, coordinate boundary may be based on statistical metrics derived from activation coordinates for previous valid calibration operations.

If the activation coordinates are verified to be within an acceptable coordinate boundary, processor 415 may store these verified coordinates in a database. Processor 415 may then utilize the verified activation coordinates as calibration reference point. Alternatively, if the coordinates for an actual activation are not valid, processor 415 may execute a recomputation of the reference calibration point. Processor 415 may generate a computed reference calibration point and utilize this computed calibration reference point as the “touchpoint” coordinates for the associated calibration target.

The processor 415 within the display module may be connected to a system database along with other display modules via a bus. Other devices (not shown) may also be connected to the bus, such as a mainframe computer, input/output devices or process control equipment. The system may be utilized for applications such as process control, ticket or seat reservations, and like applications permitting users to select choices or otherwise interact with a system by touching icons displayed on a screen.

The processor 415 may be a software update for a system that allows a touch screen and computer to work together. Processor 415 may communicate read instructions to an operating system suitable for indicating how to interpret touch event information that may be sent from the controller 410. In one embodiment, touch screen processor 415 may be a mouse-emulation type driver. For instance, contacting the surface of the touch screen may be substantially similar to clicking a mouse at the same location on the screen. In this manner a touch screen may be integrated with existing software and allow new applications to be developed without the need for touch screen specific programming. It is further contemplated that some devices, such as thin client terminals, DVD players, and specialized computer systems and the like may not require software drivers, or may include a built-in touch screen driver.

The various embodiments of the present invention contemplate a number of alternative techniques for generating a computed calibration reference point in computation step. In one embodiment, processor 415 may obtain a simple average of verified coordinate values retrieved from a database. The average may be determined by first ascertaining, for each of the verified activation coordinates from the database used, the Euclidean distance between the verified coordinates for a calibration target and the calibration reference point, as is well known in the applied mathematical arts. Then, the average may be computed by summing these distances and dividing by the number of verified coordinates used. This operation may provide an offset that may then be subtracted from the calibration reference point to determine computed reference calibration point.

In an alternative embodiment, processor 415 may utilize only the most recent verified coordinates when generating average coordinate values. For example, processor 415 may utilize the coordinates from a subset of verified actual activations for the averaging computation. In one embodiment, such an operation may be performed by only retrieving the most recent verified coordinates that have been stored. Alternatively, the database may only retain a selected number of the most recent verified coordinates. Another option for generating the computed calibration reference point uses a weighted average. For such a method, the most recent coordinates of each actual activation may be multiplied by a weighting factor to increase the influence of the most recent touches in the overall computation. Older readings may be correspondingly reduced in influence by multiplying the older reading by a fractional weighting factor. Weighting factor values may be determined empirically using well known techniques.

In an alternative embodiment, system 400 may be suitable for detecting a change in users. Change in users may be detected utilizing a login process, key cycles, seat switch, or by a dramatic shift in the accumulated centroid. System 400 may further provide automatic calibration on a per-user basis based on user factors. Detecting a change in users may accommodates differing touch styles of different individuals, objects, or the like, which may prevent false activations caused by differing touch patterns of different users. Detection of user changes may also avoid the inconvenience of manual calibration, where a user or operator is required to re-calibrate a touch screen on a regularly scheduled basis, or upon the occurrence of drift.

It is further contemplated that non-uniformities of the touch screen technology may cause linearity errors. Linearity correction may be accomplished by collecting additional reference points across the touch screen and performing scale and offset correction to each range of reference points that were touched. The data may be extrapolated to the edge of the touch screen where a display bezel may interfere with the precision of the intended touch. Additional scale and offset correction factors may be maintained across the display region to achieve data extrapolation.

Automatic calibration may prevent false activations, and may avoid the inconvenience caused by frequent manual calibration. Additionally, automatically detecting a change in users easily accommodates differing touch styles of different individuals, which prevents false activations caused by differing touch patterns of different users, and avoids the inconvenience of manual calibration.

It is to be understood that the present invention may be conveniently implemented in forms of a software package. Such a software package may be a computer program product which employs a computer-readable storage medium including stored computer code which is used to program a computer to perform the disclosed function and process of the present invention. The computer-readable medium may include, but is not limited to, any type of conventional floppy disk, optical disk, CD-ROM, magneto-optical disk, ROM, RAM, EPROM, EEPROM, magnetic or optical card, or any other suitable media for storing electronic instructions.

It is understood that the specific order or hierarchy of steps in the foregoing disclosed methods are examples of exemplary approaches. Based upon design preferences, it is understood that the specific order or hierarchy of steps in the method can be rearranged while remaining within the scope of the present invention. The accompanying method claims present elements of the various steps in a sample order, and are not meant to be limited to the specific order or hierarchy presented.

It is believed that the present invention and many of its attendant advantages will be understood by the foregoing description, and it will be apparent that various changes may be made in the form, construction and arrangement of the components thereof without departing from the scope and spirit of the invention or without sacrificing all of its material advantages. The form herein before described being merely an explanatory embodiment thereof, it is the intention of the following claims to encompass and include such changes.

What is claimed:

1. A method for calibrating a touch screen comprising
determining region parameters for a region defining a discrete input area;
accumulating a pattern of activations for a centroid within said region;
tuning a calibration factor; and
repositioning said centroid within the center of said region.

2. The method of claim 1, wherein said tuning a calibration factor is determined by centroid activation accumulations.

3. The method of claim 1, further comprising accepting a repositioning determination and fine tuning the reposition determination.

4. The method of claim 1, further comprising detecting a change in users.

5. The method of claim 1, further comprising excluding activations determined to be located within a defined distance from an outer edge of said region parameters determined for said region.

6. The method of claim 1, wherein the touch screen is a resistive, capacitive, surface acoustic, near-field or infrared touch screen.

7. The method of claim 1, wherein the touch screen is responsive to one or more distinct touch forces.

8. The method of claim 7, wherein the one or more distinct touch forces occur simultaneously.

9. A computer-readable medium having computer-executable instructions for performing a method for calibrating a touch screen comprising:
determining region parameters for a region defining a discrete area;
accumulating a pattern of activations for a centroid within said region;
tuning a calibration factor; and
repositioning said centroid within the center of said region.

10. The computer-readable medium of claim 9, wherein the touch screen is a resistive, capacitive, surface acoustic, near-field or infrared touch screen.

11. The computer-readable medium of claim 9, wherein the touch screen is responsive to one or more distinct touch forces.

12. The computer-readable medium of claim 11, wherein the one or more distinct touch forces occur simultaneously.

13. The computer-readable medium of claim 9, wherein said tuning a calibration factor is determined by centroid activation accumulations.

14. The computer-readable medium of claim 9, further having computer-executable instructions for excluding activations determined to be located within a defined distance from an outer edge of said region parameters determined for said region.

15. A system for calibrating a touch screen comprising:
a touch sensor suitable for receiving a touch sense, said touch sensor comprising a plurality of individually defined touch sensor regions;
a controller, operably coupled to said touch sensor, suitable for converting said touch sense into touch sense data; and
a processor operably coupled to said controller,
wherein said processor is suitable for determining region parameters for said plurality of touch sensor regions, accumulating a pattern of activations for a centroid within a touch sensor region, tuning a calibration factor and repositioning said centroid within the center of said touch sensor region.

16. The system of claim 15, wherein the touch sensor is suitable for providing user alteration detection.

17. The system of claim 15, wherein the touch sensor is responsive to one or more distinct touch forces occurring simultaneously.

18. The system of claim 15, wherein the controller is suitable for real-time review of touch sensor data as it is transmitted.

19. The system of claim 15, wherein the processor is a control logic processor.

20. The system of claim 15, wherein the processor stores said pattern of activations within a said touch sensor region in a database.

21. The system of claim 15, wherein the processor further excludes activations determined to be located within a defined distance from the outer edge of said region parameters.
